(19) United States
(12) Patent Application Publication
(10) Pub. No.: US 2010/0031134 A1
(43) Pub. Date: Feb. 4, 2010

(54) SYSTEM FOR ELECTRONICALLY COLLECTING AND DISTRIBUTING HEALTH INSURANCE INFORMATION

(75) Inventor: Henry V Lindeman, II, Memphis, TN (US)

Correspondence Address: BRADLEY ARANT BOULT CUMMINGS LLP;INTELLECTUAL PROPERTY DEPARTMENT, 1819 FIFTH AVENUE NORTH, BIRMINGHAM, AL, 35203-2104, US

(73) Assignee: NETFORM EXCHANGE, INC., NASHVILLE, TN (US)

(21) Appl. No.: 12/542,455

(22) Filed: Aug. 17, 2009

(51) Int. Cl. G06F 17/20; G06Q 50/00; G06F 15/16

(52) U.S. Cl. 715/226; 705/3; 715/234; 709/203

(57) ABSTRACT

A method for populating and distributing an approved health insurance carrier form is provided, as well as a machine-readable storage device programmed to carry out the method. The method involves querying a person eligible for health insurance regarding his or her health history and that of any additional insured parties, receiving the responses electronically, and storing the responses in the form of digital data. The responses are then used to automatically generate one or more populated approved forms for one or more health insurance carriers. Reminders and updates can be electronically transmitted to the eligible person when new information is needed. By requiring the person to complete a single computerized questionnaire, as opposed to numerous paper forms, the method and device greatly streamline the process of obtaining health insurance.

### BACKGROUND

A. Field of the Disclosure

The present disclosure relates generally to methods, machine-readable data storage devices, and systems for populating and distributing a carrier-approved form.

B. Background

The procurement of private health insurance is a labor-intensive process. This is due in large part to the copious information required by insurance carriers from insurance candidates. An insurer must have a comprehensive history of an individual's health and insurance coverage in order to determine whether the individual should be covered and, if so, what level of premium is warranted. In addition, in the United States each form used by each carrier containing health history queries must be approved by a state government; typically no deviations are permitted. This makes it difficult or impossible to establish a universal form by which an insurance candidate can provide carriers with his or her health history and coverage history.

The paperwork burden of obtaining health insurance has serious repercussions. It creates a barrier to individuals changing coverage or comparing coverage. Under the current system, if an individual wishes to compare the coverage and premiums offered by two carriers, the individual must fill out two complete approved carrier forms, generally by hand. If the individual wishes to compare the coverage and premiums offered by ten carriers, the individual must fill out ten complete approved carrier forms. As a result, comparing and analyzing an individual's health insurance options is virtually impossible. This prevents health care consumers from obtaining the degree of coverage they need at the most competitive prices. It creates an administrative burden for organizations such as unions and employers that provide or coordinate health insurance for their members. These burdens are not trivial considering that the cost of health care in the United States was estimated to be $2.4 trillion in 2007, representing 17% of the gross domestic product. Solutions to the problem have been complicated by complex privacy requirements governing the personal medical information that is needed by carriers to make decisions regarding potential insured parties.

There is a long-felt unmet need in the art for an efficient and automated system capable of rapidly collecting relevant information from an insurance candidate and providing that information to one or more carriers while guarding the privacy of the candidate. There is also a long-felt unmet need in the art for an efficient and automated system to provide accurate information from multiple carriers as to the coverage available and premiums required.

### SUMMARY

The above long-felt unmet needs have been fulfilled by processes, machines, manufactures, compositions of matter, and other teachings of the present disclosure. A method of populating and distributing a carrier-approved form is provided, comprising: retrieving a member list of an organization, the member list comprising a plurality of members; retrieving an approved carrier form comprising a health history query set and a format, the health history query set comprising a plurality of health history queries; receiving a response set from a given member via a user-input peripheral device, said response set comprising a plurality of responses to the health history query set; saving the response set; generating a populated carrier form comprising the response set and the format; and repeating the foregoing steps for each member. A machine-readable data storage device is provided comprising a non-volatile data storage medium on which a program is recorded, said program configured to cause a processor to perform a method of populating and distributing a carrier-approved form. A computer system for populating and distributing a carrier-approved form is provided, the system comprising a programmable computing device, said computing device comprising a communications interface and the machine-readable data storage device.

### BRIEF DESCRIPTION OF THE DRAWINGS

FIG. 1. Illustration of an embodiment of the computer system.

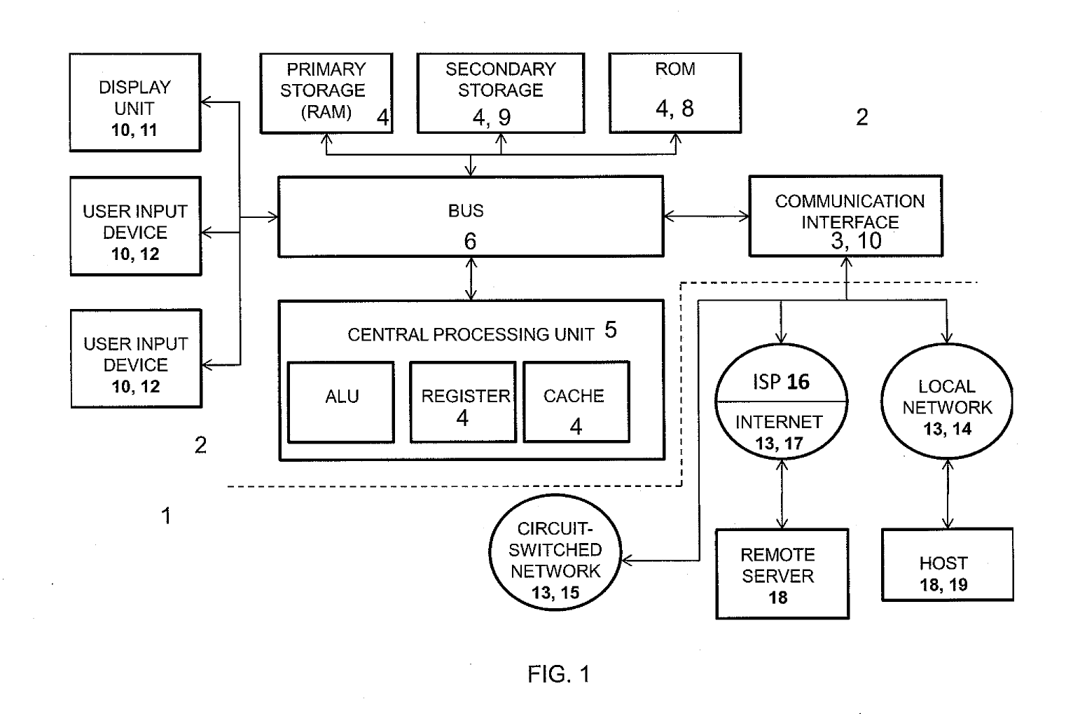

### DETAILED DESCRIPTION

### A. Definitions

The term “machine-readable data storage device” (MRDSD) as used herein refers to a device that retains data that can be read by mechanical or electronic means, for example by a computer. Such devices are sometimes referred to in the abstract as “memory,” although as used herein a machine-readable data storage device cannot comprise a human mind in whole or in part, including human memory. A MRDSD may be classified as primary, secondary, tertiary, or off-line storage. Examples of a MRDSD that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. An MRDSD that is secondary storage is not directly accessible to the central processing unit, but is accessible to the central processing unit via an input/output channel. Examples of a MRDSD that is secondary storage include a mass storage device, such as a magnetic hard disk, an optical disk, a drum drive, flash memory, a floppy disk, a magnetic tape, an optical tape, a paper tape, and a plurality of punch cards. An MRDSD that is tertiary storage is not connected to the central processing unit until it is needed, generally accessed robotically. Examples of an MRDSD that is tertiary storage may be any MRDSD that is suitable for secondary storage, but configured such that it is not constantly connected to the central processing unit. An MRDSD that is off-line storage is not connected to the central processing unit, and does not become so connected without human intervention. Examples of an MRDSD that is off-line storage may be any MRDSD that is suitable for secondary storage, but configured such that it is not constantly connected to the central processing unit, and does not become so connected without human intervention. Secondary, tertiary, and offline storage are generally non-volatile, which has the advantage of requiring no source of electrical current to maintain the recorded information.

A MRDSD cannot be construed to be a mere signal, although information may be communicated to and from an MRDSD via a signal.

The term “electronic communications network” as used herein refers to a network capable of transferring information spatially by conducting electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network may be for example electronic mail, an SMS text message, and a digital file sent via file transfer protocol (FTP). Information sent via a circuit-switched network may be for example a voice mail message, a facsimile message, an SMS text message, and a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “including” as used herein is non-exclusive, and can be read to mean “including but not limited to” unless explicitly stated otherwise.

All pronouns should be read such that the singular encompasses the plural, the plural encompasses the singular, the male encompasses the female, and the female encompasses the male.

### B. METHODS OF POPULATING AND DISTRIBUTING A CARRIER-APPROVED FORM

A method of populating and distributing a carrier-approved form is provided, comprising: retrieving a member list of an organization, the member list comprising a plurality of members; retrieving an approved carrier form comprising a health history query set and a format, the health history query set comprising a plurality of health history queries; receiving a response set from a given member via a user-input peripheral device, said response set comprising a plurality of responses to the health history query set; saving the response set; generating a populated carrier form comprising the response set and the format; and repeating the foregoing steps for each member.

The carrier-approved form is a digital representation of a paper health insurance application form. In the United States, such forms must be approved by state regulatory agencies and cannot deviate from their approved content and format. The form in its paper version is a long series of questions directed to a primary insured (who is a member of an organization in the context of this disclosure) that are relevant to an insurance carrier. The approved form referred to in the disclosure comprises one or more data files in digital format, comprising information dictating the format according to the paper form and comprising a plurality of variables corresponding to health history queries.

The format comprises instructions that, when read by a computing device, cause the device to produce an image of a populated carrier form in a certain specified layout. The image may be a printed image, an image on a visual display unit, or an image produced by any other suitable device known in the art. In some embodiments of the method, the image will be saved to a MRDSD as a file. The file may be in any suitable format, for example in portable document format (“PDF”), MICROSOFT WORD format, MICROSOFT PAGEMAKER format, WORDPERFECT format, ASCII text-file format, hypertext markup language format, rich text format, Amazon DRM restricted rights format, JPEG, GIF, PNG, BMP, and unicode text. The layout comprises the contents of each page of the populated carrier and the location of the contents on each page. Such contents include query text (text specifying a question to be answered), text of responses to the health history query set, headers, text identifying the carrier, text identifying the organization, text identifying the form number and revision date, lines, boxes, text of disclaimers, text of instructions, and any of the numerous other layout elements that are understood by those skilled in the art to be suitable or necessary in an approved carrier form.

The organization is any group of one or more persons that provides or coordinates the provision of health care coverage to one or more members. The organization may be an employer. The organization may be a business entity, for example a sole proprietorship, a corporation, a partnership, a limited liability company, a limited liability partnership, a business trust, a co-op, or other business entity. The organization may exist for non-business purposes, for example for charitable purposes. The purposes need not solely include the provision or coordination of provision of health care coverage to members.

The member list comprises a set of unique data elements, each corresponding to a unique member. The data element can be any datum that can be linked to the member. Examples include an employee number, a social security number, a full name, a driver's license number, a professional license number, a birth date, an arbitrary identification string, a portion of any of the foregoing, and a combination of any of the foregoing.

In some embodiments of the method, the member list is retrieved from a MRDSD. In some embodiments of the method, the member list is retrieved by a CPU via a connection to a MRDSD that is primary or secondary storage. In some embodiments of the method the member list may be retrieved over an electronic communications network.

In some embodiments of the method, the approved carrier form is retrieved from a MRDSD by a CPU. The form may be retrieved by the CPU via a direct connection to a MRDSD that is primary or secondary storage or it may be retrieved over an electronic communications network.

The approved carrier form comprises a health history query set. The health history query set comprises a plurality of health history queries. A health history query is a question regarding any past event that may have some bearing on the current or future health of an insured associated with the member. Such events may have been experienced by the insured, or such events may have been experienced by a person genetically related to the insured. In this context an event may include the date of the insured's birth or the insured's sex. Some relevant events may be social, as opposed to medical, such as a marriage, divorce, or prior coverage history. Some events may be more conventionally medical events. A subordinate health history query may be related to a superior health history query, such that the subordinate health history query occurs only if a certain response is received to the superior health history query. An example of such a relationship is the dominant health history query “Do you now or have you ever in the past smoked cigarettes?” and the subordinate health history query “How many packs of cigarettes per day?” which is presented only if a positive response is received to the dominant query. In some embodiments of the health history query set, a query that is subordinate to a first query may be superior to a second query, creating a hierarchical structure of queries.

Some embodiments of the health history query comprise a standard set of queries as to whether a past diagnosis or other indication has been received of a condition or disease state. Such conditions or disease states may include cancer, types of cancer, heart attack, congestive heart failure, angioplasty, vascular stent, stroke, aneurysm, angina, serious heart disorder, bypass, elevated cholesterol, elevated lipids, elevated triglycerides, heart disease, irregular heartbeat, heart murmur, chest pain, heart valve conditions; phlebitis, pace maker, coronary artery disease, hemophilia, von Willebrand disease, sickle cell anemia, blood clots, varicose veins, arterial disease, anemia, Kawasaki disease, hypertension, premature birth, parentage of a premature child, gestational period of premature child, date of birth, complications of premature child, present pregnancy, pregnancy due date, multiple pregnancy (and expected number of children), high risk pregnancy, fatherhood of present pregnancy, ulcerative colitis, proctitus, Crohn's disease, diverticulitis, stomach ulcers, hernia, gallbladder disease, gallstones, pituitary disorders, esophagitis, colon disorders, rectal disorders, irritable bowel syndrome, chronic diarrhea, pancreas disorder, chronic pancreatitis, liver disorders, cirrhosis of the liver, hepatitis A, hepatitis B, hepatitis C, hepatitis D, hepatitis E, gastroesophageal reflux disease, ulcer, obesity, gastric bypass, growth hormones, Addison's disease, Gaucher's disease, Cushing's disease, menopause, goiter, Alzheimer's disease, cerebral palsy, migraines, fainting spells, tumor, head injury or trauma, spinal injury or trauma, cyst, multiple sclerosis, muscular dystrophy, paralysis, Parkinson's disease, Lou Gehrig disease, attention-deficit hyperactivity disorder, alcohol or drug abuse treatment, membership in Alcoholics Anonymous (or other substance abuse program), outpatient therapy for a nervous disorder, outpatient therapy for a mental disorder, outpatient therapy for a eating disorder, inpatient stay at a mental health hospital, inpatient stay for ethanol dependency, inpatient stay for drug dependency, inpatient stay for anxiety, inpatient stay for depression, chronic fatigue syndrome, bipolar disorder (manic depression), schizophrenia, autism, suicide attempt, mental retardation, polio, hemiplegia, epilepsy, seizures, seizure frequency, date of last seizure, HIV positive, AIDS, discoid lupus, systemic lupus, scleroderma, amyotrophic lateral sclerosis, psoriasis, immunodeficiency, connective tissue disorder, rheumatoid arthritis, idiopathic thrombocytopenic purpura, myasthenia gravis, Hashimoto's thyroiditis, a lung disorder, cystic fibrosis, emphysema, chronic obstructive pulmonary disorder, sarcoidosis, selective immunoglobulin a (IgA) deficiency, tuberculosis, pneumothorax, sleep apnea, respiratory syncytial virus infection, Rous sarcoma virus infection, asthma, bronchitis, pneumonia, allergies, hay fever, acoustic neuroma, chronic ear infections, cleft lip, cleft palate, deviated septum, chronic sinusitis, glaucoma, retinopathy, cataracts, urinary disorder, urinary tract infection, kidney disorder, renal failure, condition requiring dialysis, bladder disorder, neurogenic bladder, adrenal gland disorder, thyroid gland disorder, prostate disorder, testicular condition, ostomy, kidney stones, polycystic kidney disease, erectile dysfunction, cystocele, rectocele, enlarged lymph nodes, diabetes, type I diabetes, type II diabetes, insulin dependence, glycohemoglobin AlC test date and results, blood sugar level test date and results, diabetes-related eye disorders, diabetes-related hypertension, diabetes-related kidney disease, diabetes-related heart disease, diabetes-related neuropathy, rheumatoid arthritis, sciatica, arthritis, burn, bulging disc, herniated disc, osteoarthritis, joint injury, joint pain, prosthetic device, bone disorder, fractures, fibromyalgia, chronic fatigue syndrome, shoulder disorder, knee disorder, back disorder, back pain, neck disorder, neck pain, spina bifida, muscular dystrophy, lost limb, other physical impairment or deformity, acne, psoriasis, gout, Sjogren's syndrome, past transplant, bone marrow transplant, organ transplant, organ transplant donor, stem cell transplant, reason for transplant, and transplant rejection.

Some embodiments of the health history query set comprise a query directed to a symptom. Examples of the symptom include chest pain, heart problems, jaundice, abdominal pain, digestive problems, leg ulcers, congestive health failure, nasal congestion, nasal bleeding, paralysis, abnormal menstrual cycles, renal insufficiency, hepatitis, hearing loss, sensory loss, neurological conditions, stroke, joint pain, frequent fevers, frequent infections, hematuria, cysts, bladder spasms, bladder problems, fatigue, infertility, bone disease, bone marrow disease, speech difficulty, joint replacement, and other symptoms.

Some embodiments of the health history query set comprise a query directed to a condition or treatment not otherwise disclosed. Examples of such queries include whether one has been advised to or plans to have surgery, hospitalization, treatment, therapy, counseling, medical testing, examinations or special immunizations not otherwise disclosed; whether one has any pending test results related to a condition not otherwise disclosed; whether one has been hospitalized or had surgery in the past five years for a condition not otherwise disclosed; whether one has had claims in excess of $25,000 for a condition not otherwise disclosed; whether one has had claims in excess of $7,500 in the last three years for a condition not otherwise disclosed; whether one has been prescribed three or more different medications for any one condition not otherwise disclosed; whether one has been on disability from work more than two weeks due to a condition not otherwise disclosed; whether one has had an abnormal test or routine physical results not otherwise disclosed; whether one has received workers compensation benefits within the last year; whether one has a pending workers compensation claim due to a condition not otherwise disclosed; whether one has been referred to a specialist for a condition not otherwise disclosed; whether one plans diagnostic testing or surgery for a condition not otherwise disclosed; whether one has taken medication during the past twelve months for a condition not otherwise disclosed; whether one is currently taking medication not otherwise disclosed; whether one has seen a doctor during the past twelve months for a condition not otherwise disclosed; and whether one has any other medical condition not otherwise disclosed.

Some embodiments of the health history query comprise a standard set of subordinate queries for each query directed to past conditions, symptoms, treatments, or disease states. Such subordinate queries may include diagnosis date, name of physician, date of initial treatment, whether it is an ongoing condition, last treatment date, frequency of past medical provider visits, prior hospitalization, prior hospitalization dates, prior therapy, prior therapy dates, prior surgery, prior surgery dates, prior prescription drugs, prior prescription drugs list, dates of planned provider visits, future hospitalization, future hospitalization dates, future therapy, future therapy dates, future surgery, future surgery dates, future prescription drugs, date last saw doctor, and physical restrictions.

A response set is received from a responder. The response set comprises a plurality of responses to at least one of the queries in the health history query set. Generally the responder will be required to provide some response to each query in the health history query set. The responder is a party authorized to provide private health information under applicable laws. The responder may be the insured. If the insured is not the member, the member may be the responder if the member is authorized to provide medical information on behalf of the insured (either as a result of explicit authority or some inherent authority, such as a parent's authority to provide a child's private medical information). In some embodiments of the method information not purely related to medical history, such as coverage history, date of birth, and sex, may be provided by another party, such as the organization. In some embodiments of the method the authorized party may be a third party that has been granted explicit permission to provide the information, for example a physician who has treated the member.

In some embodiments of the method the response is received via a user-input peripheral device, such as a keyboard. Any suitable user-input peripheral device may be used. Under some circumstances an operator of the peripheral device will serve to enter the responses for the responder, for example if the responder is physically unable to operate the peripheral device. In some embodiments of the method, once the response is received from the user-input peripheral device, it is saved to a MRDSD in one or more files.

In some embodiments of the method the response set is received via an electronic communications network.

A populated carrier form is generated comprising the format and the response set. The populated carrier form comprises a file that can be converted to an image substantially identical in appearance to an approved carrier form, displaying the same layout, questions, and other elements. The image may be a printed image, an image on a visual display unit, or an image produced by any other suitable device known in the art.

The previously described steps of the method may be repeated as necessary for each member.

Some embodiments of the method further comprise transmitting the populated carrier form to the carrier. In some embodiments the populated carrier form is printed, and the hardcopy is transmitted to the carrier via mail, courier, facsimile, or any other suitable means. In some embodiments of the method the populated carrier form is transmitted electronically to the carrier. Such electronic transmission will occur via an electronic communications network, for example via electronic mail or an SMS text message.

In some embodiments of the method, more than one approved carrier form can be populated and distributed for a given member. Such embodiments of the method further comprise retrieving an additional approved carrier form comprising an additional health history query set and an additional format, the additional health history query set comprising an additional plurality of health history queries; receiving an additional carrier response set from the given member via a user-input peripheral device, said additional carrier response set comprising a plurality of responses to the additional carrier health history query set; saving the additional carrier response set; generating an additional populated carrier form comprising the additional carrier response set and the additional format; and transmitting the populated approved carrier form to an additional carrier.

The additional approved carrier form serves the same purpose as the approved carrier form described above. It also comprises a format and an additional health history query set. The additional health history query set comprises an additional plurality of health history queries. The additional health history queries may be any query suitable as the health history query. The first health history query set and the additional health history query set may overlap completely, partially, or not at all. In each of these three cases, responses are only required for the union of the first health history query set and the additional health history query set; if a given query is an element of two health history query sets, only one response need be received for the query. In embodiments of the method comprising many approved carrier forms, great efficiencies in the member's time and labor can be realized by eliminating the need for the member to respond to redundant queries. Some embodiments of the method comprise retrieving the additional approved carrier form from a MRDSD and saving the carrier response set to a MRDSD.

Some embodiments of the method allow the member to specify an additional insured on his or her policy. Such embodiments further comprise receiving a datum via a user-input peripheral device from the given member representing the number of insured associated with the given member, wherein the number of insured is greater than one; receiving an additional insured response set from the given member via a user-input peripheral device, said additional insured response set comprising a plurality of responses to the health history query set; generating an additional populated carrier form comprising the additional insured response set and the format; and transmitting the additional insured populated carrier form to the carrier.

Some embodiments of the method allow the organization to receive a status report of its membership's progress in responding to the health history query set. Such embodiments comprise receiving a completion status query from the organization; transmitting a completion status report to the organization, said report comprising a completion status of each of the plurality of members, not comprising a private response to the health history query set. The private response is a response pertaining to private medical information that is not otherwise known to the organization. In some embodiments of the method, the completion status query is received via an electronic communication network. The completion status query may be received by a computing device, which then responds by transmitting the completion status report to the organization via an electronic communication system. The completion status report will not include information that could constitute private medical information about an insured. The status report may state that a certain fraction of all members have completed responses, or that a certain member has completed a certain fraction of the response set.

Some embodiments of the method automatically notify the members when they are eligible to change their enrollment status. Such embodiments further comprise sending an enrollment notification to the given member via an electronic communications network. The notification may be any suitable form of electronic communication, such as electronic mail, an SMS text message, a page, or a voice mail message. The timing of the notification will generally coincide with an enrollment-status event, such as the initiation of an open season, a birth, a loss in spousal coverage, a gain of spousal coverage, new employment, new membership in the organization, or another event affecting the coverage of the member or other insured.

Some embodiments of the method respond to the addition of a new member to the organization by automatically notifying the new member of an opportunity for enrollment, populating an approved carrier form for the new member, and transmitting the populated carrier form to the carrier. Such methods further comprise receiving a new member notification from the organization via an electronic communications network; sending an enrollment notification to the new member via a electronic communication network; receiving a new member response set from the new member via a user-input peripheral device, the new member response set comprising a plurality of responses to the health history query set; generating a new member populated carrier form comprising the new member response set and the format; saving the new member populated carrier form; and transmitting the new member populated approved carrier form to the carrier. The new member notification may be any suitable form of electronic communication, such as electronic mail or an SMS text message. The new member notification may also comprise saving the new member's information to a MRDSD; this in turn may trigger the addition of the new member to the member list. In some embodiments of the method the new member populated carrier form is saved to a MRDSD.

The enrollment notification may be any suitable form of electronic communication, such as electronic mail, an SMS text message, a page, or a voice mail message. The new member response set will comprise a plurality of responses to a plurality of health history queries. The plurality of health history queries will be the union of one or more health history query sets. The new member populated carrier form is generated by any means suitable to generate the populated carrier form described elsewhere. The new member populated carrier form may be saved and transmitted by means suitable to save or transmit the first populated carrier form.

Some embodiments of the method are web-based methods, involving the use of hypertext markup language files. Such embodiments have the advantage of relying on web browsing software that is ubiquitous on personal computers. In such embodiments receiving the response set further comprises transmitting to the given member via a packet-switched network a query form that is readable by a hypertext markup language browser. In some embodiments of the method the query form is an interactive hypertext form. Such interactive hypertext forms provide a convenient text or graphical user interface format wherein responses can be provided by one or more of text, radio buttons, menu bars, buttons, drop-down lists, check boxes, and other HTML elements understood by those skilled in the art. In some embodiments of the method, the query form is an HTML document comprising embedded scripting language code.

Some embodiments of the method will further comprise transmitting to the organization an update notice and receiving at least one updated response set. The notice may be sent via an electronic communication network. In some embodiments of the method the notice is sent via facsimile, electronic mail, or SMS text message. The updated response set comprises a response to a health history query. The updated response set will comprise a response that was not previously provided, either because no response was provided or because a previous response was provided with different information. The updated response set reflects the changing nature of health history, coverage, marital status, number of insured parties associated with the member, and other relevant information. The updated response set may comprise a response to a query from one or more of the health history query set and the additional health history query set.

The updated response set may update at least of one the response set, the additional carrier response set, the additional insured response set, and the new member response set. In such embodiments the updated response set may be saved to a MRDSD. In some embodiments of the method the update notice is sent at a pre-determined time interval, such as a year, a half-year, or a quarter.

Some embodiments of the method comprise validation steps for any response set or datum received from the member. Such methods of validation are known by those skilled in the art and can be practiced without undue experimentation. If a given response cannot be validated, an exception notification will be sent to the organization or the member.

### C. Machine-Readable Data Storage Devices Comprising a Program

A machine-readable data storage device is provided, comprising a non-volatile data storage medium on which a program is recorded, said program configured to cause a processor to perform any of the methods disclosed herein.

Further provided is a MRDSD comprising a stored program, wherein the stored program comprises: a module for sending an enrollment notification to a member of an organization; a module for retrieving an approved carrier form comprising a health history query set and a format, the health history query set comprising a plurality of health history queries; a module for receiving a response set from the member comprising a plurality of responses to the health history query set; a module for generating a populated carrier form comprising the response set and the format; and a module for transmitting the populated carrier form to the carrier. The modules may accomplish their purposes by any of the methods described herein.

### D. Computer Systems

A computer system 1 for populating and distributing a carrier-approved form, the system comprising a programmable computing device 2, said computing device comprising a communications interface 3 and an MRDSD 4. Some embodiments of the system comprise an MRDSD 4 comprising a non-volatile data storage medium on which a program is recorded, said program configured to cause a processor 5 to perform any of the methods disclosed herein. Some embodiments of the program comprise: a module for sending an enrollment notification to a member of an organization; a module for retrieving an approved carrier form comprising a health history query set and a format, the health history query set comprising a plurality of health history queries; a module for receiving a response set from the member comprising a plurality of responses to the health history query set; a module for generating a populated carrier form comprising the response set and the format; and a module for transmitting the populated carrier form to the carrier.

The computer system 1 includes a bus 6 or other communication mechanism for communicating information, and a processor 5 coupled with bus 6 for processing information. The computer system also includes a MRDSD that is primary storage 7, such as a random access memory (RAM) or other dynamic storage device, coupled to the bus 6 for storing information and instructions to be executed by the processor 5. Primary storage 7 also may be used for storing temporary variables or other intermediate information during execution of instructions by the processor 5. The computer system further includes a read only memory (ROM) 8 or other static MRDSD coupled to the bus 6 for storing static information and instructions for the processor 5. A secondary MRDSD 9 is provided and coupled to a bus 6.

The computer system may be coupled via bus 6 to one or more peripheral devices 10. The peripheral device may be for example a peripheral display 11, such as a visual display unit, for displaying information to a computer user. A peripheral user-input device 12, including alphanumeric and other keys, may be coupled to a bus for communicating information and command selections to the processor. Another type of user-input device is cursor control, such as a mouse, a trackball, or cursor direction keys for communicating direction information and command selections to the processor and for controlling cursor movement on the display. The cursor control device typically has two degrees of freedom in two axes, a first axis (e.g., x) and a second axis (e.g., y), that allows the device to specify positions in a plane.

According to one embodiment of the invention, a form is populated and distributed by the computer system 1 in response to the processor 5 executing one or more sequences of one or more instructions contained in an MRDSD 4. Such instructions may be read from another MRDSD 4. Execution of the sequences of instructions contained in the MRDSD 4 causes the processor to perform the method described herein. One or more processors 5 in a multi-processing arrangement may also be employed to execute the sequences of instructions contained in the MRDSD 4. In alternative embodiments, hard-wired circuitry may be used in place of or in combination with software instructions to implement the invention. Thus, embodiments of the invention are not limited to any specific combination of hardware circuitry and software.

Various forms of computer-readable media may be involved in carrying one or more sequences of one or more instructions to the processor for execution. For example, the instructions may initially be borne on a magnetic disk of a remote computer 18. The remote computer 18 can load the instructions into its dynamic memory and send the instructions over a telephone line 15 using a modem. A modem local to the computer system 1 can receive the data on the telephone line 15 and use an infrared transmitter to convert the data to an infrared signal. An infrared detector coupled to the bus 6 can receive the data carried in the infrared signal and place the data on the bus. The bus 6 carries the data to the main memory 4, from which the processor 5 retrieves and executes the instructions. The instructions received by the main memory may optionally be stored on the storage device either before or after execution by the processor.

The computer system 1 may include a communication interface 3 coupled to the bus 6. The communication interface 3 provides a two-way data communication via an electronic communications network 13. Some embodiments of the communication interface 3 are coupled to a network link that is connected to a local network 14. For example, the communication interface 3 may be an integrated services digital network (ISDN) card or a modem to provide a data communication connection to a corresponding type of telephone line 15. As another example, the communication interface may be a local area network (LAN) card to provide a data communication connection to a compatible LAN 14. Wireless links may also be implemented. In any such implementation, the communication interface sends and receives electrical, electromagnetic, or optical signals that carry digital data streams representing various type of information. However, the communications interface cannot be construed to be a mere signal. The network link typically provides data communication through one or more networks to other data devices.

For example, the network link may provide a connection through the local network 14 to the host computer 19 or to data equipment operated by an Internet Service Provider (ISP) 16. The ISP 16 in turn provides data communication services through the worldwide packet-switched network, now commonly referred to as the “Internet” 17. The computer system 1 can send messages and receive data, including program codes, through the network(s) 13, the network link, and the communication interface 3. In the Internet example, a server 18 might transmit a requested code for an application program through the Internet 17, the ISP, the local network 14, and the communication interface 3. In accordance with one aspect of the invention, one such downloaded application provides for the methods as described herein. The received code may be executed by the processor 5 as it is received, and/or stored on a MRDSD 4, or on non-volatile storage for later execution.

### E. Examples

1. Broker System Based on the World Wide Web

One exemplary embodiment of the method is a web-based method of servicing the organization by an insurance broker or other party that communicates directly with insurance carriers on behalf of organizations and their members. The organization is provided with login information that grants access to a web page that allows the organization to provide the member list, update the member list, specify acceptable carriers, send the status completion query, receive the completion status report, view premium estimates, and compare premium estimates. As is known to those skilled in the art, a “web page” is a set of one or more HTML documents that refer to one another via embedded hyperlinks, and generally comprise additional data such as text, graphics, and hyperlinks to additional resources and files. The login information is preferably secure, to prevent unauthorized access to private personal and business information.

Alternate embodiments provide a secure FTP site by which the organization can upload and download the member list, updates to the member list, lists of acceptable carriers, completion status reports, and premium estimates.

The member is also provided with login information granting the member access to a web page that allows the member to provide the response set to one or more health history query sets, provide the datum representing the number of insured associated with the given member, provide an additional insured response set, view premium estimates, select a carrier, receive the enrollment notification, and provide the new member response set.

The member may optionally receive the enrollment notification independent of the web page, for example via an electronic communication network. Notifications may be sent for example via a voice mail, an SMS text message, or an electronic mail message. The member may specify the manner in which communications will be sent to the member via the web page.

When a response set has been received, it is saved to a non-volatile MRDSD. One or more populated carrier forms are generated for the carriers selected. The carrier forms may be sent via an electronic communications network to the one or more carriers. If the carrier cannot accept electronic communications, the form may be printed and sent to the carrier via post or courier.

The method may be performed by computer systems as described herein, and by machine-readable data storage devices comprising a non-volatile data storage medium on which a program is recorded, as described herein.

2. Carrier Run System

The methods, systems and devices provided herein may function to exchange information between a carrier and a second party without intervention by a broker; the second party may be the organization or the member. In this example the member list and the response set are received by the carrier. In some versions of the example one or more of the additional carrier response sets, the datum representing the number of insured associated with the member, the additional insured response set, the completion status query, and the new member notification are received by the carrier. In some versions of the example one or more of the completion status report and the enrollment notification are transmitted by the carrier.

In this example the populated carrier form need not be transmitted to the carrier, insofar as the carrier receives the information needed to populate and generate the form directly from the member. It is within the scope of this example that the carrier could provide populated forms to other carriers, in which case such populated outside carrier forms would be transmitted to the outside carrier by any means disclosed as suitable for transmission to the carrier in this disclosure.

3. Organization Run System

The methods, systems and devices provided herein may function to exchange information between the organization and one or more carriers without the intervention of a broker. In this example the organization receives the approved carrier form and the response set. In some versions of the example, the organization receives one or more of the additional approved carrier form, the additional carrier response set, the datum representing the number of insured associated with the member, and the additional insured response set. In some versions of the example, the organization transmits one or more of the populated carrier form, the additional populated carrier form, the additional insured populated carrier form, the enrollment notification and the new member populated carrier form. In this example the completion status query and completion status report may not be necessary, as the organization itself will be able to view the completion status of the membership or a given member. In some versions of this example the organization cannot view one or more query responses in the response set, the additional carrier response set, the additional insured response set, and the new member response set; this may be required to preserve the privacy of the medical information of the insured.

In this example the packet-switched network may be the Internet, or it may be a local area network (LAN) accessible to members. One example of such a LAN is a workplace LAN accessible to employees via each employee's desktop computer.

### F. Conclusions

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

I claim:

1. A method of populating and distributing a carrier-approved form, comprising:
(a) retrieving a member list of an organization from a machine-readable data storage device (MRDSD), the member list comprising a plurality of members;
(b) retrieving an approved carrier form comprising a health history query set and a format from a MRDSD, the health history query set comprising a plurality of health history queries;
(c) receiving a response set from a given member via a user-input peripheral device, said response set comprising a plurality of responses to the health history query set;
(d) saving the response set to a MRDSD;
(e) generating a populated carrier form comprising the response set and the format;
and
(f) repeating steps (a)-(e) for each member.

2. The method of claim 1, further comprising transmitting the populated carrier form to a carrier.

3. The method of claim 2, further comprising:
(a) retrieving an additional approved carrier form comprising an additional health history query set and an additional format from a MRDSD, the additional health history query set comprising an additional plurality of health history queries;
(b) receiving an additional carrier response set from the given member via a user-input peripheral device, said additional carrier response set comprising a plurality of responses to the additional carrier health history query set;
(c) saving the additional carrier response set to a MRDSD;
(d) generating an additional populated carrier form comprising the additional carrier response set and the additional format; and
(e) transmitting the additional populated carrier form to an additional carrier.

4. The method of claim 2, further comprising:
(a) receiving a datum via a user-input peripheral device from the given member representing the number of insured associated with the given member, wherein the number of insured is greater than one;
(b) receiving an additional insured response set from the given member via a user-input peripheral device, said additional insured response set comprising a plurality of responses to the health history query set;
(c) generating an additional populated carrier form comprising the additional insured response set and the format; and
(d) transmitting the additional insured populated carrier form to the carrier.

5. The method of claim 2, wherein the response set is received via a packet-switched network

6. The method of claim 2, wherein the member list is received via a packet-switched network.

7. The method of claim 2, further comprising:
(a) receiving a completion status query from the organization;
(b) transmitting a completion status report to the organization, said report comprising a completion status of each of the plurality of members, not comprising a private response to the health history query set.

8. The method of claim 2, further comprising sending an enrollment notification to the given member via a packet-switched network.

9. The method of claim 2, further comprising:
(a) receiving a new member notification from the organization via a packet-switched network;
(b) sending an enrollment notification to the new member via a packet-switched network;
(c) receiving a new member response set from the new member via a user-input peripheral device, the new member response, set comprising a plurality of responses to the health history query set;
(d) generating a new member populated carrier form comprising the new member response set and the format;
(e) saving the new member populated carrier form to a MRDSD; and
(f) transmitting the new member populated approved carrier form to the carrier.

10. The method of claim 2, wherein receiving the response set further comprises transmitting to the given member via a packet-switched network a query form that is readable by a hypertext markup language browser.

11. The method of claim 10, wherein the query form is an interactive hypertext form.

12. The method of claim 10, wherein the query form is an HTML document comprising embedded scripting language code.

13. A machine-readable data storage device (MRDSD) comprising a non-volatile data storage medium on which a program is recorded, said program configured to cause a processor to perform a method that comprises:
(a) retrieving a member list of an organization, the member list comprising a plurality of members;
(b) retrieving an approved carrier form comprising a health history query set and a format, the health history query set comprising a plurality of health history queries;
(c) receiving a response set from a given member, said response set comprising a plurality of responses to the health history query set;
(d) saving the response set;
(e) generating a populated carrier form comprising the response set and the format, and
(f) repeating steps (a)-(e) for each said member.

14. The MRDSD of claim 13, the method further comprising transmitting the populated carrier form to a carrier.

15. The MRDSD of claim 14, the method further comprising:
(a) retrieving an additional approved carrier form comprising an additional health history query set and an additional format, the additional health history query set comprising an additional plurality of health history queries;
(b) receiving an additional carrier response set from the given member, said additional carrier response set comprising a plurality of responses to the additional carrier health history query set;
(c) generating an additional populated carrier form comprising the additional carrier response set and the additional format; and
(d) transmitting the additional populated carrier form to an additional carrier.

16. The MRDSD of claim 14, the method further comprising:
(a) receiving a datum from the given member representing the number of insured associated with the given member, wherein the number of insured is greater than one;
(b) receiving an additional insured response set from the given member, said additional insured response set comprising a plurality of responses to the health history query set;
(c) generating an additional populated approved carrier form comprising the additional insured response set and the format; and
(d) transmitting the additional insured populated approved carrier form to a carrier.

17. The MRDSD of claim 14, the method further comprising:
(a) receiving a completion status query from the organization; and
(b) transmitting a completion status report to the organization, said report comprising the completion status of each of the plurality of members, not comprising an element of the query response set.

18. The MRDSD of claim 14, the method further comprising sending an enrollment notification to the given member via a packet-switched network.

19. The MRDSD of claim 14, the method further comprising:
(a) receiving a new member notification from the organization;
(b) sending an enrollment notification to the new member;
(c) receiving a new member response set from the new member, said response set comprising a plurality of responses to the health history query set;
(d) generating a new member populated carrier form comprising the new member response set and the format; and
(e) transmitting the new member populated carrier form to a carrier.

20. The MRDSD of claim 14, wherein receiving the response set further comprises transmitting to the given member a query form that is readable by a hypertext markup language browser.

21. The MRDSD of claim 20, wherein the query form is an interactive hypertext form.

22. The MRDSD of claim 20, wherein the query form is an HTML document comprising embedded scripting language code.

23. A system for populating and distributing a carrier-approved form, the system comprising a programmable computing device, said computing device comprising a communications interface and the MRDSD of claim 13.

24. An MRDSD comprising a stored program, wherein the stored program comprises:
(a) a module for sending an enrollment notification to a member of an organization;
(b) a module for retrieving an approved carrier form comprising a health history query set and a format, the health history query set comprising a plurality of health history queries;
(c) a module for receiving a response set from the member comprising a plurality of responses to the health history query set;
(d) a module for generating a populated carrier form comprising the response set and the format; and
(e) a module for transmitting the populated carrier form to the carrier.
